(19) United States
(12) Patent Application Publication
(10) Pub. No.: US 2026/0066680 A1
(43) Pub. Date: Mar. 5, 2026

(54) BALANCE AND SAFETY DISCHARGE CIRCUIT FOR ENERGY STORAGE DEVICES

(71) Applicant: VERTIV CORPORATION, Westerville, OH (US)

(72) Inventor: William M. Dixon, Lewis Center, OH (US)

(21) Appl. No.: 19/284,040

(22) Filed: Jul. 29, 2025

Related U.S. Application Data
(60) Provisional application No. 63/687,499, filed on Aug. 27, 2024.

(51) Int. Cl. H02J 7/00

(52) U.S. Cl. CPC H02J 7/64; H02J 7/52; H02J 7/933; H02J 2207/50

(57) ABSTRACT

An energy storage apparatus and methodology for controlling discharge of an energy storage apparatus. In embodiments, the apparatus includes a plurality of energy storage devices connected in series, a plurality of discharge resistors connected in parallel to the energy storage devices, a plurality of electrically operated switches connected between the energy storage devices and the discharge resistors, and a controller connected to the electrically operated switches. In use, the controller is configured to output an electrical signal to the electrically operated switches, and the presence or absence of the electrical signal is determinative of an open or closed state of the switches corresponding to respective inactive and active discharge states of the energy storage devices.

### CROSS REFERENCE TO RELATED APPLICATION

The present application claims priority to U.S. Provisional Patent Application No. 63/687,499, filed August 27, 2024, which is incorporated herein by reference in its entirety.

### TECHNICAL FIELD

The present disclosure is directed generally to energy storage devices, and more particularly, to a safety discharge circuit and methodology for energy storage devices connected in series.

### BACKGROUND

Energy storage devices such as capacitors, supercapacitors, and battery cells can be arranged in series to increase operating voltage, available power, and available energy. Because the current during charging and discharging is identical for each series device, and because the capacity and impedance of each series device can vary (e.g., due to manufacturing process tolerances), the voltages and thus the state of charge of the series devices often drift apart. In addition, when a device containing stored energy is installed, serviced, or removed and disposed, the stored energy presents a danger to people and property in the event of a short circuit.

Current solutions for safety discharge and mitigating voltage drift utilize resistors in schemes whereby discharge is constant. To maximize discharge rate, comparatively large resistors may be utilized at the expense of energy loss and efficiency. To minimize energy loss, comparatively small resistors may be utilized at the expense of an acceptable discharge rate. In addition to constant resistors, other current solutions utilize solid-state controls including software or firmware, at the expense of cost and complexity to the system.

Therefore, in view of the disadvantages of current solutions, what is needed is a solution for safety discharge and balancing that can be made active or inactive automatically and without the need for software or firmware.

### SUMMARY

According to a first aspect, the present disclosure is directed to an energy storage apparatus. In embodiments, the energy storage apparatus includes a plurality of energy storage devices connected in series, a plurality of discharge resistors connected in parallel to the energy storage devices, a plurality of electrically operated switches connected between the energy storage devices and the discharge resistors, and a controller connected to the electrically operated switches. In use, the controller configured to output an electrical signal to the electrically operated switches, and a presence or absence of the output of the electrical signal is determinative of a discharge state of the energy storage devices.

In some embodiments, the presence of the electrical signal output to the electrically operated switches corresponds to an open state of the electrically operated switches corresponding to an inactive discharge state of the energy storage devices.

In some embodiments, the absence of the electrical signal output to the electrically operated switches corresponds to a closed state of the electrically operated switches corresponding to an active discharge state of the energy storage devices.

In some embodiments, the controller is configured to output a further electrical signal to the electrically operated switches, the further electrical signal output responsive to a determined overvoltage or unbalanced condition of the energy storage devices, and the presence of the further electrical signal corresponding to a closed state of the electrically operated switches corresponding to a further active discharge state of the energy storage devices.

In some embodiments, the energy storage devices are tolerant of discharge to zero volts.

In some embodiments, the energy storage devices are capacitors, supercapacitors, or batteries.

In some embodiments, the electrically operated switches are relays or transistors.

In some embodiments, the electrical signal is an AC or DC electrical signal.

According to another aspect, the present disclosure is directed to a safety discharge circuit for energy storage devices connected in series. In embodiments, the safety discharge circuit includes a plurality of energy storage devices, each energy storage device connected in parallel to a discharge resistor, and an electrically controllable switch connected between each energy storage device and each respective discharge resistor, and a controller connected to the electrically controllable switches. In use, the controller is configured to output an electrical signal to the electrically controllable switches, and a presence or absence of the output of the electrical signal is determinative of a discharge state of the energy storage devices.

In some embodiments, the presence of the electrical signal output to the electrically operated switches corresponds to an open state of the electrically operated switches corresponding to an inactive discharge state of the energy storage devices, and the absence of the electrical signal output to the electrically operated switches corresponds to a closed stated of the electrically operated switches corresponding to an active discharge state of the energy storage devices.

In some embodiments, in the closed state of the electrically operated switches, conductive pathways are formed between the energy storage devices and the respective discharge resistors such that current flows from the energy storage devices to the respective discharge resistors, and in the open state of the electrically operated switches, the conductive pathways are interrupted between the energy storage devices and the respective discharge resistors such that no current flows from the energy storage devices to the respective discharge resistors.

According to a further aspect, the present disclosure is directed to a method for safety discharging energy storage devices connected in series. In embodiments, the method includes providing an energy storage apparatus including a plurality of energy storage devices connected in series, a plurality of discharge resistors connected in parallel to the energy storage devices, a plurality of electrically operated switches connected between the energy storage devices and the discharge resistors, and a controller connected to the electrically operated switches and configured to output an electrical signal to the electrically operated switches, wherein a presence or absence of the output of the electrical signal is determinative of a discharge state of the energy storage devices. The method further includes outputting, by the controller, the electrical signal to the electrically operated switches to maintain the electrically operated switches in an open state corresponding to an inactive discharge state of the energy storage devices. The method further includes interrupting, by the controller, the electrical signal output to the electrically operated switches to cause the electrically operated switches to close corresponding to an active discharge state of the energy storage devices.

In some embodiments, the interruption of the electrical signal output by the controller is caused by an interruption of power supplied to the controller.

In some embodiments, the method further includes determining, by the controller or by an output to the controller, an overvoltage condition of the plurality of energy storage devices, and outputting, by the controller, a further electrical signal to the plurality of electrically operated switches to close the plurality of electrically operated switches to discharge the energy storage devices to alleviate the overvoltage condition.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the present disclosure disclosed herein may be better understood when consideration is given to the following detailed description thereof. Such description refers to the included drawings, which are not necessarily to scale, and in which some features may be exaggerated, and some features may be omitted or may be represented schematically in the interest of clarity. Like reference numerals in the drawings may represent and refer to the same or similar element, feature, or function. In the drawings:

FIG. 1 is a circuit diagram illustrating an energy storage apparatus in an inactive discharge state, in accordance with an exemplary embodiment of the present disclosure;

FIG. 2 is a circuit diagram illustrating the energy storage apparatus in an active discharge state, in accordance with an exemplary embodiment of the present disclosure; and

FIG. 3 is a flow diagram illustrating a safety discharge methodology for energy storage devices connected in series, in accordance with an exemplary embodiment of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Broadly, the present disclosure is directed to energy discharge apparatus and methodologies for energy storage devices connected in series, for instance capacitors, supercapacitors, and batteries (e.g., electrochemical batteries such as sodium-ion batteries), as well as other types of devices tolerant of discharge to zero volts. In embodiments, energy discharge is achieved via conductive pathways formable between the energy storage devices and respective drain resistors. In embodiments, the drain resistors may be sized, or multiple drain resistors connected in series, to provide rapid discharge when needed, for instance when the energy storage devices or apparatus including the same are installed, serviced, or removed/disposed. The discharging functionality can be made active or inactive by forming or respectively interrupting the conductive pathways.

In embodiments, the change between active and inactive is achieved via electrically operated switches, for instance relays or transistors. In embodiments, the electrically operated switches are connected to a controller, for instance a comparator, configured to output an electrical signal (e.g., AC or DC). In embodiments, the electrically operated switches are ‘closed’ (i.e., make contact) to form the conductive pathways to allow discharge, and are ‘open’ (i.e., break contact) to interrupt the conductive pathways to prevent discharge. In embodiments, the controller may be configured to output different electrical signals each corresponding to a differential operational state of the apparatus, for instance full discharge or balancing. In some embodiments, the electronically operated switches may be maintained open in the presence of the output signal, and close automatically in the absence of the output signal, thereby providing a safety provision for automatically discharging the energy storage devices in the event of power loss.

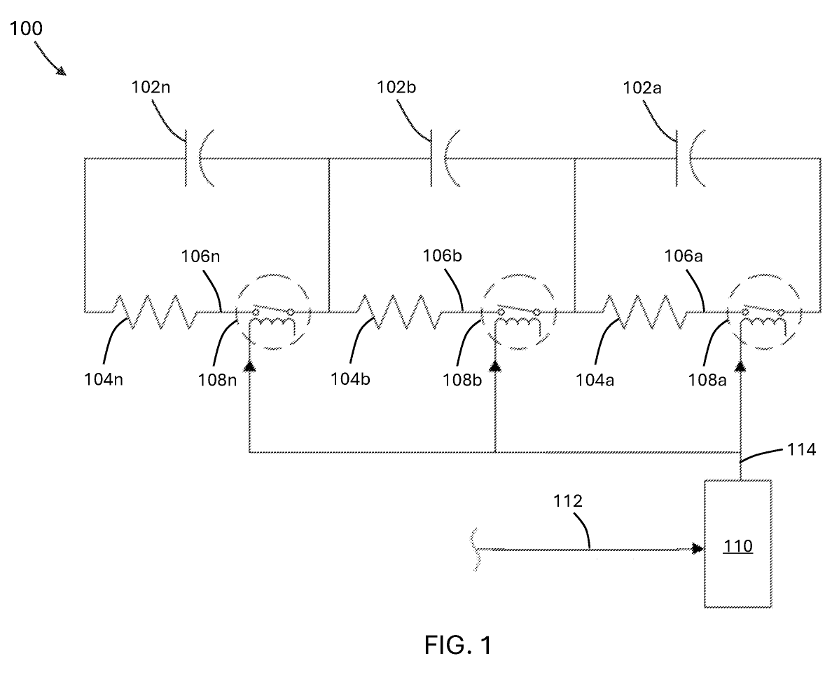

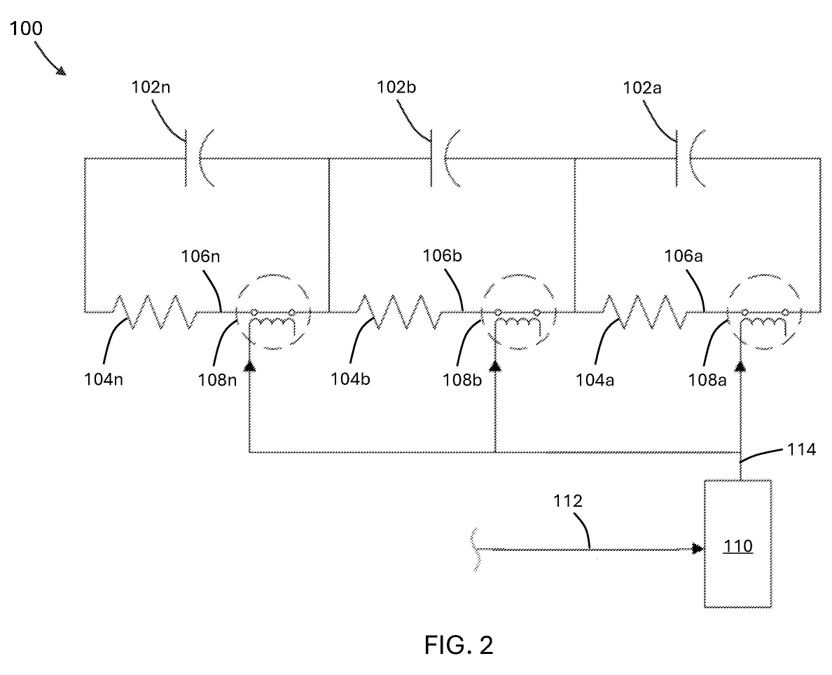

Referring to FIGS. 1 and 2, a circuit diagram illustrating a non-limiting example of an energy storage apparatus is shown at 100. The apparatus 100 includes a plurality of energy storage devices 102a, 102b…102n connected in series. While the energy storage devices 102a, 102b…102n are shown symbolically as capacitors, it is understood that other types of energy storage devices may be substituted, such as supercapacitors and batteries, among others. The energy storage devices 102a, 102b…102n are connected in series such that a consistent charge level is maintained across the set of devices.

Each energy storage device 102a, 102b…102n is connected in parallel to at least one discharge resistor depicted as discharge resistors 104a, 104b…104n. While a single discharge resistor is shown associated with each energy storage device 102a, 102b…102n, it is understood that more than one discharge resistor may be utilized, for instance a plurality of smaller resistors connected in series. The type(s), number, and resistor scheme may be customized based on the power application.

Conductive pathways 106a, 106b…106n between the energy storage devices 102a, 102b…102n and the discharge resistors 104a, 104b…104n form discharge circuits that allow current to flow from the energy storage devices 102a, 102b…102n to the respective discharge resistors 104a, 104b…104n. Each conductive pathway 106a, 106b…106n includes an electrically operated switch 108a, 108b…108n. In use, each electrically operated switch 108a, 108b…108n is operative to make continuous or interrupt the conductive pathways 106a, 106b…106n depending on the operating state of the circuit. While the electrically operated switches 108a, 108b…108n are shown symbolically as relays, it is understood that other switch types may be substituted, for example MOSFET switches.

As shown in FIG. 1, the electrically operated switches 108a, 108b…108n are shown in an ‘open’ state breaking contact thereby interrupting the conductive pathways 106a, 106b…106n. The open state of the electrically operated switches 108a, 108b…108n corresponds to an inactive state of the circuit in which discharge is prevented or stopped. As shown in FIG. 2, the electrically operated switches 108a, 108b…108n are shown in a ‘closed’ state making contact thereby making continuous the conductive pathways 106a, 106b…106n. The closed state of the electrically operated switches 108a, 108b…108n corresponds to an active state of the circuit in which discharge occurs.

Each electrically operated switch 108a, 108b…108n is electrically connected to a controller 110, for instance a comparator or integrated functionality of a comparator, operable for switching the circuit between the inactive and active operating states. In embodiments, the controller 110 is electrically powered via a power supply 112 (e.g., charging source) and is configured to output an electrical signal 114 (e.g., AC or DC) to each of the connected electrically operated switches 108a, 108b…108n.

In use when powered, the controller 110 is configured to output the electrical signal 114 to each of the connected electrically operated switches 108a, 108b…108n to maintain the switches open thereby preventing discharge. In embodiments, the inactive state of the discharge circuit corresponds to an operating state of the apparatus 100 in which no efficiency is lost due to resistor drain. In use when unpowered (e.g., disconnected from the charging source), the controller 110 is unable to output the electrical signal which causes each of the electrically operated switches 108a, 108b…108n to close automatically thereby activating the discharge circuit. In embodiments, the active state of the discharge circuit corresponds to a maintenance or disposal state of the apparatus 100 in which the energy storage devices 102a, 102b…102b are subject to constant drain to depletion.

Whereas the above describes an operating scheme in which the electrically operated switches 108a, 108b…108n open and close synchronously in the respective presence or absence of an electrical signal, in an alternative embodiment, the operating scheme may operate via a threshold scheme. For example, the electrically operated switches 108a, 108b…108b may be maintained open in the presence of an electrical signal output exceeding a predefined threshold signal strength and may close automatically when the signal strength degrades below the predefined threshold signal strength. In embodiments, the predefined threshold signal strength may be tuned based on the capabilities of the controller, types of power storage devices, input power, overall system power, etc.

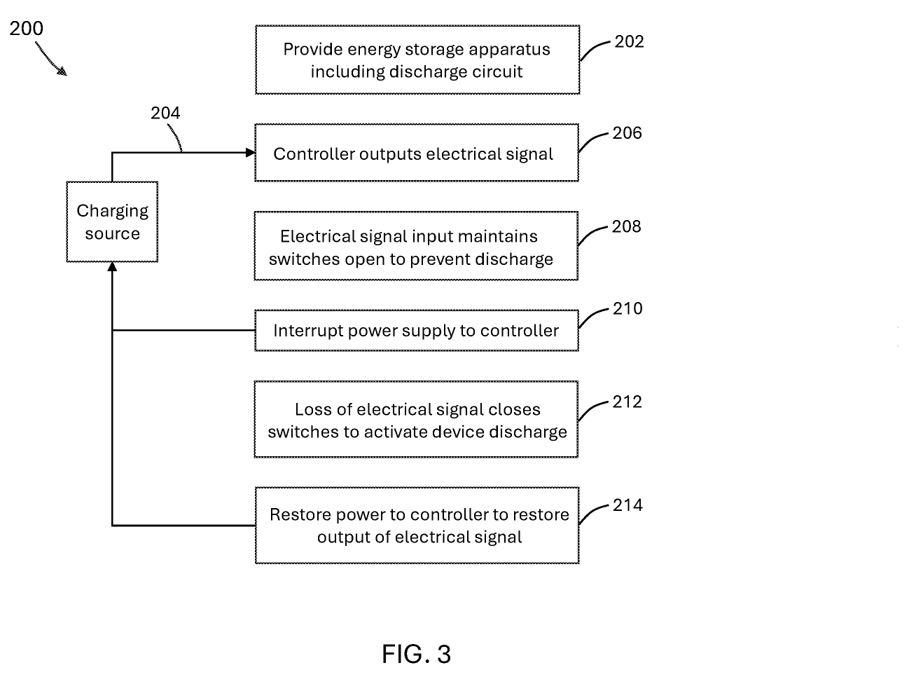

Referring to FIG. 3, a control methodology, no limiting to any particular sequence or synchronization of steps, for operating the energy discharge apparatus is shown at 200. In Step 202, the method includes providing an apparatus including series connected energy storage devices 102a, 102b…102n, connected discharge resistors 104a, 104b…104n, connected electrically operated switches 108a, 108b…108n, and controller 110 arranged according to the scheme(s) as described above. In Step 204, electrical energy is supplied to the controller. In Step 206, the powered controller operates to output an electrical signal to the connected electrically operated switches. In Step 208, receipt of the electrical signal maintains the electrically operated switches open.

In Step 210, in the event of power loss (e.g., when the circuit is desired to be removed or disconnected from the system or in the case of system malfunction) the output of the electrical signal by the controller is interrupted. In Step 212, when the electrically operated switches stop receiving the electrical signal, the electrically operated switches close automatically to make active the discharge state of the circuit to drain energy stored in the energy storage devices. In Step 214, when power is restored, the electrical signal is again output to the electrically operated switches thereby causing the switches to remain open until the next power loss event.

The energy storage apparatus 100 and control methodology 200 may further include or be compatible for use with a separate system for balancing the energy storage devices 102a, 102b…102n. For example, the controller 110 be configured to monitor the state of charge of the energy storage devices 102a, 102b…102n by determining a voltage of each device, comparing the determined voltages to a reference voltage, and making the apparatus active or inactive to maintain the voltages within a predefined range, among other balancing schemes. In some embodiments, the controller 110 may be configured to output a further electrical signal corresponding to an instruction to open or close one or more of the electrically operated switches to respectively stop or start discharge, for example, in the presence of an overvoltage, undervoltage or overtemperature condition.

From the above description, it is clear that the present disclosure disclosed herein is well adapted to achieve the objectives and to attain the advantages mentioned herein as well as those inherent in the present disclosure disclosed herein. While exemplary embodiments of the present disclosure disclosed herein has been described for purposes of this disclosure, it will be understood that numerous changes may be made which will readily suggest themselves to those skilled in the art and which are accomplished within the broad scope and coverage of the present disclosure disclosed and claimed herein.

What is claimed is:

1. An energy storage apparatus, comprising:
a plurality of energy storage devices connected in series;
a plurality of discharge resistors, each discharge resistor connected in parallel to one of the energy storage devices;
a plurality of electrically operated switches, each electrically operated switch connected between one of the energy storage devices and a respective one of the discharge resistors; and
a controller connected to the electrically operated switches and connectable to a power supply, the controller configured to output an electrical signal to the electrically operated switches, wherein a presence or absence of the output of the electrical signal determines a discharge state of the energy storage devices.

2. The energy storage apparatus according to claim 1, wherein the presence of the electrical signal output to the electrically operated switches corresponds to an open state of the electrically operated switches corresponding to an inactive discharge state of the energy storage devices.

3. The energy storage apparatus according to claim 1, wherein the absence of the electrical signal output to the electrically operated switches corresponds to a closed state of the electrically operated switches corresponding to an active discharge state of the energy storage devices.

4. The energy storage apparatus according to claim 1, wherein the controller is configured to output a further electrical signal to the electrically operated switches, the further electrical signal output responsive to a determined overvoltage or unbalanced condition of the energy storage devices, and the presence of the further electrical signal corresponding to a closed state of the electrically operated switches corresponding to a further active discharge state of the energy storage devices.

5. The energy storage apparatus according to claim 1, wherein the energy storage devices are tolerant of discharge to zero volts.

6. The energy storage apparatus according to claim 1, wherein the energy storage devices are capacitors, supercapacitors, or batteries.

7. The energy storage apparatus according to claim 1, wherein the electrically operated switches are relays or transistors.

8. The energy storage apparatus according to claim 1, wherein the electrical signal is an AC or DC electrical signal.

9. A safety discharge circuit for energy storage devices connected in series, comprising:
a plurality of energy storage devices, each energy storage device connected in parallel to a discharge resistor, and an electrically controllable switch connected between each energy storage device and each respective discharge resistor; and
a controller connected to the electrically controllable switches and connectable to a charging source;
wherein:
the controller is configured to output an electrical signal to the electrically controllable switches; and
a presence or absence of the output of the electrical signal is determinative of a discharge state of the energy storage devices.

10. The safety discharge circuit according to claim 9, wherein:
the presence of the electrical signal output to the electrically operated switches corresponds to an open state of the electrically operated switches corresponding to an inactive discharge state of the energy storage devices; and
the absence of the electrical signal output to the electrically operated switches corresponds to a closed state of the electrically operated switches corresponding to an active discharge state of the energy storage devices.

11. The safety discharge circuit according to claim 10, wherein:
in the closed state of the electrically operated switches, conductive pathways are formed between the energy storage devices and the respective discharge resistors such that current flows from the energy storage devices to the respective discharge resistors; and
in the open state of the electrically operated switches, the conductive pathways are interrupted between the energy storage devices and the respective discharge resistors such that no current flows from the energy storage devices to the respective discharge resistors.

12. The safety discharge circuit according to claim 9, wherein the energy storage devices are tolerant of discharge to zero volts.

13. The safety discharge circuit according to claim 9, wherein the energy storage devices are capacitors, supercapacitors, or batteries.

14. The safety discharge circuit according to claim 9, wherein the electrically operated switches are relays or transistors.

15. A method for safety discharging energy storage devices connected in series, the method comprising the steps of:
providing an energy storage apparatus including:
a plurality of energy storage devices connected in series;
a plurality of discharge resistors, each discharge resistor connected in parallel to one of the energy storage devices;
a plurality of electrically operated switches, each electrically operated switch connected between one of the energy storage devices and a respective one of the discharge resistors; and
a controller connected to the electrically operated switches and connectable to a charging source, the controller configured to output an electrical signal to the electrically operated switches, wherein a presence or absence of the output of the electrical signal is determinative of a discharge state of the energy storage devices;
outputting, by the controller, the electrical signal to the electrically operated switches to maintain the electrically operated switches in an open state corresponding to an inactive discharge state of the energy storage devices; and
interrupting, by the controller, the electrical signal output to the electrically operated switches to cause the electrically operated switches to close corresponding to an active discharge state of the energy storage devices.

16. The method according to claim 15, wherein the interruption of the electrical signal output by the controller is caused by an interruption of power supplied to the controller.

17. The method according to claim 15, further comprising the steps of:
determining, by the controller or by an output to the controller, an overvoltage condition of the plurality of energy storage devices; and
outputting, by the controller, a further electrical signal to the plurality of electrically operated switches to close the plurality of electrically operated switches to discharge the energy storage devices to alleviate the overvoltage condition.

18. The method according to claim 15, wherein the energy storage devices are tolerant of discharge to zero volts.

19. The method according to claim 15, wherein the energy storage devices are capacitors, supercapacitors, or batteries.

20. The method according to claim 15, wherein the electrically operated switches are relays or transistors.
